(19) United States
(12) Patent Application Publication
(10) Pub. No.: US 2005/0190922 A1
(43) Pub. Date: Sep. 1, 2005

(54) Secure use of a single single-photon detector in a QKD system

(76) Inventor: Michael J. LaGasse, Nahant, MA (US)

Correspondence Address: OPTICUS IP, 7791 Alister Mackenzle Dr., SARASOTA, FL, 34240, US

(21) Appl. No.: 11/030,241

(22) Filed: Jan. 6, 2005

Related U.S. Application Data
(60) Provisional application No. 60/548,475, filed on Feb. 28, 2004.

(51) Int. Cl. H04L 9/00

(52) U.S. Cl. 380/278; 380/256

(57) ABSTRACT

A method of using a single single-photon detector (SPD) in a quantum key distribution (QKD) system is described. The method includes modulating a phase of a quantum signal a first time at a first QKD station by applying a first phase modulation randomly selected from a set of four possible phase modulations. The method also includes modulating the phase of the quantum signal a second time. The second modulation involves applying a second phase modulation randomly selected from the same set of four possible phase modulations. The method is a modification of the BB84 protocol and represents a higher level of quantum security than either the BB84 or B92 protocols when using a QKD system with a single SPD.

### RELATED CO-PENDING APPLICATIONS

The present application is related to U.S. Provisional Patent Application Ser. No. 60/548,475, filed on Feb. 28, 2004, and entitled “compact optical assembly for a QKD system.”

### FIELD OF THE INVENTION

The present invention relates to quantum cryptography, optical assemblies for QKD systems, and the use of using a single single-photon detector (SPD) in a quantum key distribution (QKD system) in a manner that maintains system security.

### BACKGROUND OF THE INVENTION

Quantum key distribution involves establishing a key between a sender (“Alice”) and a receiver (“Bob”) by using weak (e.g., 0.1 photon on average) optical signals transmitted over a “quantum channel.” The security of the key distribution is based on the quantum mechanical principle that any measurement of a quantum system in unknown state will modify its state. As a consequence, an eavesdropper (“Eve”) that attempts to intercept or otherwise measure the quantum signal will introduce errors into the transmitted signals, thereby revealing her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984)(hereinafter, “Bennett & Brassard”). Specific QKD systems are described in publications by C. H. Bennett et al entitled “Experimental Quantum Cryptography” and by C. H. Bennett entitled “Quantum Cryptography Using Any Two Non-Orthogonal States”, Phys. Rev. Lett. 68 3121 (1992) (hereinafter, “Bennett 1992”), and in U.S. Pat. No. 5,307,410 to Bennett (“the '410 patent”).

The general process for performing QKD is described in the book by Bouwmeester et al., “The Physics of Quantum Information,” Springer-Verlag 2001, in Section 2.3, pages 27-33. During the QKD process, Alice uses a true random number generator (RNG) to generate a random bit for the basis (“basis bit”) and a random bit for the key (“key bit”) to create a qubit (e.g., using polarization or phase encoding) and sends this qubit to Bob.

Generally, there are two types of QKD systems discussed in the literature: one-way systems and two-way systems. These two types of systems are discussed below in connection with using one or two SPDs for detecting the quantum signal.

One-Way Systems with a Single SPD

The above mentioned publications and patent each describe a so-called “one-way” QKD system wherein Alice randomly encodes the polarization or phase of single photons, and Bob randomly measures the polarization or phase of the photons. In a one-way QKD system, respective parts of the interferometric system are accessible by Alice and Bob so that each can control the phase of the interferometer. The signals (pulses) sent from Alice to Bob are time-multiplexed and follow different paths. As a consequence, the interferometers need to be actively stabilized to within a few tens of (nanometers) during transmission to compensate for thermal drifts.

The one-way systems described in Bennett 1992 and in the '410 patent are based on double optical fiber Mach-Zehnder interferometer and the use of a single single-photon detector (SPD). These one-ways systems use the “B92” protocol, also known as the “two-state” protocol, as set forth in Bennett 1992. In the B92 protocol, ALICE randomly selects a phase modulation from a set of two possible modulation states, and BOB randomly selects a phase modulation state from the same set of two modulation states.

While the B92 protocol is convenient to use, for lossy and noisy realistic channels, it provides unconditional security only if BOB's detector can discriminate between single photon, vacuum and multi-photon states, as described in the article by K. Tamaki and N. Luetkenhaus, entitled “Unconditional Security of the Bennett 92 quantum key-distribution over lossy and noisy channel,” available at arXiv.org on-line archive preprint quant-ph/0308048. Commercially available SPDs do not comply with this requirement.

Two-Way QKD Systems with One or Two SPDs

U.S. Pat. No. 6,438,234 to Gisin (the '234 patent), which patent is incorporated herein by reference, discloses a so-called “two-way” QKD system that is autocompensated for polarization and thermal variations, and that utilizes either one or two SPDs.

FIG. 1 is a schematic diagram of a two-way QKD system 10 based on the '234 patent and that includes a conventional fiber-optic-based two-SPD QKD station BOB. The BOB of FIG. 1 is shown in FIG. 4 of the article by Bethune and Park, “Autocompensating quantum cryptography,” New Journal of Physics 4, (2002) 42.1-42.15 (hereinafter, “the Bethune Article”) which Article is incorporated by reference herein. QKD transmitter BOB serves as a transmitter and receiver and includes a distributed feedback (DFB) laser 12, a variable optical attenuator (VOA) 14, a polarization controller 16 and a circulator 18, all coupled in series via respective optical fiber sections 20.

One port of circulator 18 is coupled via an optical fiber section 21 to a polarization-maintaining (PM) variable coupler 26. One port of the PM variable coupler 26 is coupled to an optical fiber section 22A that in turn is coupled to a coupler 30. Another port of coupler 26 is coupled to another optical fiber section 22B that includes a phase modulator 34. Optical fiber section 22B is also coupled to coupler 30. A third port of coupler 26 is coupled to an optical fiber section 40 that leads to a first single-photon detector (SPD) D1. Also, one of the ports of circulator 18 is coupled to an optical fiber 42 that leads to a second SPD D2. SPDs D1 and D2 are coupled to a controller 50. Controller 50 is also coupled to phase modulator 34. Controller 50 also has a random number generator (RNG) (not shown) which assures a random choice of a phase modulator 34 state out of a protocol-determined set of states. The fast-slow coupler 28 couples two polarization-maintaining fibers with their fast axes perpendicular, thus assuring rotation of polarization.

In operation, light pulses P0 are emitted by laser 12 and attenuated by VOA 14. The attenuated light pulses are then polarized by polarization controller 16. Circulator 18 passes the pulses P0 to PM variable coupler 26. At PM variable coupler 26, each light pulse is split into two light pulses PA and PB having different polarizations, with one light pulse (say, PA) directed to optical fiber section 22A, while the other light pulse (PB) is directed to optical fiber section 22B. Because pulses PA and PB are outgoing, pulse PB remains unmodulated by phase modulator 34. These pulses are then re-introduced into optical fiber channel 60 at with a time delay.

Pulses PA and PB travel over fiber channel 60 to a second QKD station ALICE, where one of the pulses (say, PB) is randomly phase-modulated by a second phase modulator 70 after reflecting from a Faraday mirror 72, which rotates the polarizations of the pulses by 90°. Controller 80 has an RNG (not shown) which assures a random choice of phase imparted by phase modulator 70 by randomly selecting a phase modulation from protocol-determined set of possible phase modulations.

Pulses PA and PB then travel back to BOB over fiber channel 60. At coupler 30, pulse PA is directed into fiber section 22B, where it is randomly phase modulated by phase modulator 34 via the operation of controller 50. Because pulse PA now is time-delayed by the same amount as pulse PB, it combines with pulse PB at PM variable coupler 26, where the pulses interfere with one another. Depending on the relative phase imparted to the pulses, the resulting combined pulse will either travel over optical fiber section 40 to SPD D1 or over optical fiber section 42 to SPD D2. The detection events are then counted as clicks in controller 50. These clicks are then processed using known techniques (e.g., sifting, error correction and privacy amplification), to create a secret quantum key shared by BOB and ALICE.

When the QKD system 10 is run under the BB84 protocol (presented in Bennett and Brassard), phase modulator 70 at ALICE is modulated by controller 80 so that it is in one of four possible modulation states, e.g. −3π/4, −π/4, π/4 or 3π/4. Correspondingly, phase modulator 34 at BOB is modulated by controller 50 so that it can be in one of two possible modulations taken from the group of four modulation states. For example, the two randomly selectable modulations at BOB might be −π/4 and π/4.

The operation of QKD system 10 is secure because it utilizes two SPDs D1 and D2. However, the use of two SPDs significantly increases the cost of a commercial QKD apparatus. On the other hand, mere elimination of, say, detector D2 results in a single-SPD QKD system. Unfortunately, this compromises the security of the system in view of the information an eavesdropper can obtain by observing detection events (“clicks”) at the remaining detector D1. This is the case, for example, in the two-way single-SPD QKD systems in the '234 patent run using either the BB84 or B92 protocols.

Accordingly, there is a need for an approach to using a single SPD in a QKD system in a manner that maintains system security.

### SUMMARY OF THE INVENTION

An aspect of the invention is a method of using a single single-photon detector (SPD) in a quantum key distribution (QKD) system. The method includes modulating a phase of a quantum signal a first time at a first QKD station by applying a first phase modulation randomly selected from a set of four possible phase modulations. The method also includes—at a second QKD station operably coupled to the first QKD station and having the single SPD—modulating the phase of the quantum signal a second time by applying a second phase modulation randomly selected from the set of four possible phase modulations.

A second aspect of the invention is a method of detecting quantum signals in a quantum key distribution (QKD) station having a single single-photon detector (SPD). The method includes applying a first phase modulation to each quantum signal at a first QKD station operably coupled to a second QKD station, and applying a second phase modulation to each quantum signal at the second QKD station. The method also includes detecting the twice-modulated quantum signal with the single SPD. In the method, the first and second phase modulations are each randomly selected from one set of four possible phase modulations.

A third aspect of the invention is a method of forming a quantum key by using either of the above-described methods, and further including: recording the first and second phase modulations for each quantum signal and forming a sifted key, performing error correction on the sifted key, and performing privacy amplification on the error-corrected key to form the quantum key.

### BRIEF DESCRIPTION OF THE DRAWINGS

FIG. 1 is a schematic diagram of a prior-art two-way QKD system having a conventional fiber-optics-based QKD stations BOB and ALICE;

FIG. 2 is a schematic diagram of an example embodiment of the compact single-SPD QKD station BOB as part of a two-way QKD system; and

FIG. 3 is a schematic diagram similar to FIG. 2, but wherein the polarizer is arranged outside the housing so that the housing only encompasses two beamsplitters; and

FIG. 4 is a schematic diagram of an example embodiment of a single-SPD bulk-optics one-way system that employs two QKD stations each including the optical assembly of the present invention, wherein each the optical assembly consists of two prisms.

The various elements depicted in the drawings are merely representational and are not necessarily drawn to scale. Certain sections thereof may be exaggerated, while others may be minimized. The drawings are intended to illustrate various embodiments of the invention that can be understood and appropriately carried out by those of ordinary skill in the art.

### DETAILED DESCRIPTION OF THE INVENTION

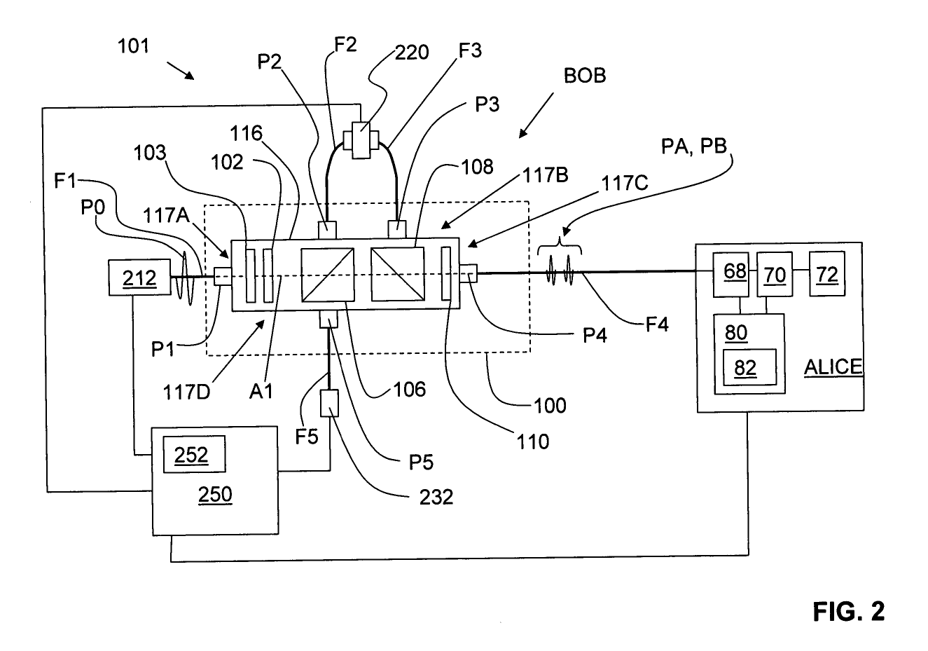

FIG. 2 is a schematic diagram of an example embodiment of a QKD system 101 that includes a compact single-SPD QKD station BOB. BOB includes an optical assembly 100 having, order along an optical axis Al from left to right, an optional variable or fixed optical attenuator 103 (e.g., having an attenuation of about 10 dB to 20 dB), a polarizer 102, a 50:50 beamsplitter 106, a polarizing beamsplitter 108, and an optional optical filter 110 (collectively referred to also as “elements 102 through 110”).

In an example embodiment, elements 102 through 110 are in contact so that there are no airspaces between them. In another example embodiment, some or all of these elements are separated from one another, as shown in FIG. 2, and include antireflection (AR) coatings on the element faces on which light is incident.

Elements VOA and 102 through 110 are held in place within a housing 116 having sides 117A, 117B, 117C and 117D. In an example embodiment, housing 116 is made metal, and elements 102 through 110 are held to the housing by epoxy.

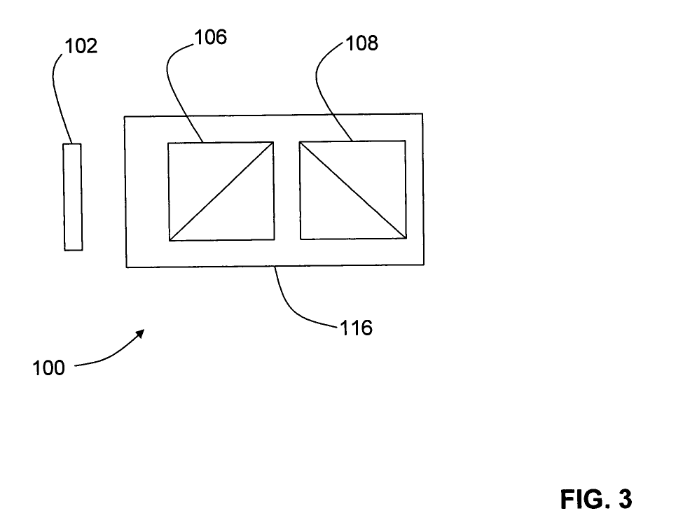

In an example embodiment of assembly 100 illustrated in FIG. 3, polarizer 102 is not present and is external to the housing. This embodiment allows for an assembly 100 that consists of only two prisms within housing 116.

With reference again to FIG. 2, in an example embodiment, beamsplitters 106 and 108 are made of glass, such as BK-7 or other suitable optical-quality glass, capable of efficiently transmitting light having a wavelength of 1550 nm. Also in an example embodiment, each beamsplitter is a cube having a dimension of about 0.375″ on a side. In another example embodiment, housing 116 has overall dimensions of about 3″×0.6″×0.6″.

Assembly 100 includes a first port P1 at side 117A that serves as an input port. Assembly 100 also includes second and third ports P2 and P3 at side 117B coupled to beamsplitters 106 and 108 respectively. Assembly 100 also includes a fourth port P4 at side 117C and coupled to optional optical filter 110, if present, or alternative to beamsplitter 108. Assembly 100 further includes fifth port P5 at side 117D coupled to beamsplitter 106.

With continuing reference to FIG. 2, in an example embodiment, ports P1-P5 are fiber optic couplers adapted to couple at one end to an optical fiber section, and are adapted to collimate light from the coupled optical fiber to form a collimated light beam. The collimated light beam is then transmitted to the adjacent element in the assembly. Likewise, ports P1-P5 as fiber optic couplers are adapted to receive collimated light from an element of the assembly and focus the light so that it is coupled into the optical fiber connected to the port.

In an example embodiment, ports P1-P5 include a lens, such a gradient-index (GRIN) lens, that serve as a collimating lens between the optical fiber and the corresponding element in assembly 100. Also in an example embodiment, ports P1-P5 as fiber optic couplers are adjustable to adjust the direction the light travels through assembly 100. Example adjustable fiber optic couplers suitable for use with the present invention are described in the article by Garland Best and Omur M Sezerman, entitled “Shedding light on hybrid optics: A tutorial in coupling,” Optics and Photonics News, February 1999 (pp. 30-34), which article is incorporated by reference herein. In an example embodiment, light is transmitted along the slow axis of the optical fiber sections, in accordance with standard industry practice.

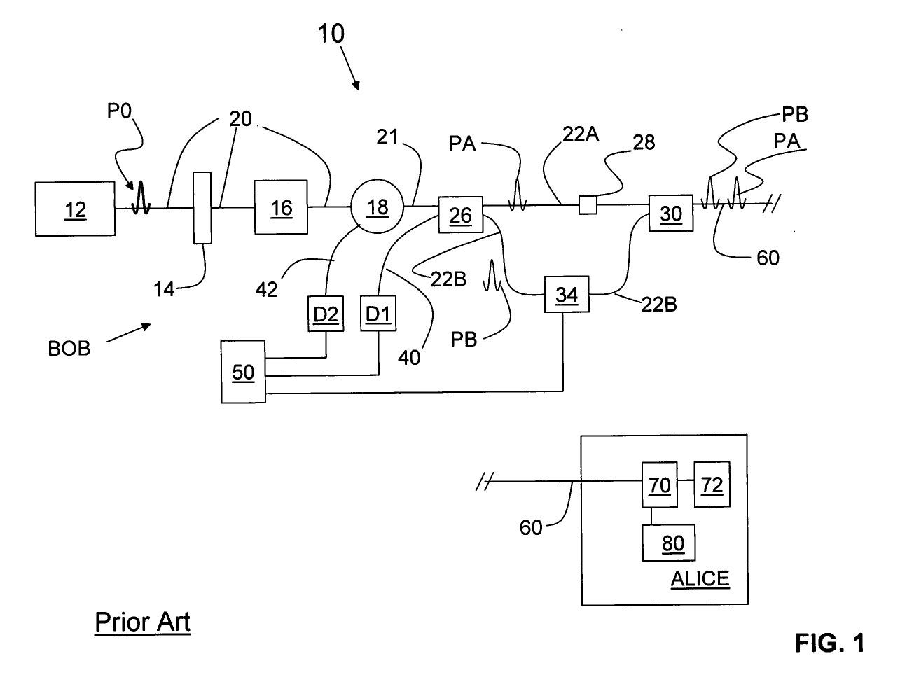

QKD optical assembly 100 serves as a compact optical layer for a single-SPD QKD station BOB as part of two-way QKD system 101 similar to QKD system 10 as discussed above in connection with FIG. 1. With continuing reference to FIG. 2, QKD station BOB includes a laser source 212 coupled to a first optical fiber section F1, which in turn is coupled to port P1. BOB also includes optical fiber sections F2 and F3 respectively coupled to ports P2 and P3. Optical fiber sections F2 and F3 are also respectively coupled to a phase modulator 220 to complete the optical path between ports P2 and P3. BOB also includes a single SPD 232 coupled to port P5 via optical fiber section F5. Thus, port P5 is also referred to herein as “detector port.”An optical fiber section F4 is also coupled to port P4, wherein optical fiber section F4 is the “quantum channel” connecting BOB to ALICE in QKD system 101. In an example embodiment, optical fiber sections F1, F2, and F3 are polarization-maintaining (PM) fibers, while optical fiber sections F4 and F5 are single-mode (SM) fibers. QKD system 101 also includes a controller 250 operably coupled to SPD 232, to phase modulator 220, and to laser source 212, wherein the controller is adapted to control and coordinate the operation of these elements. Controller 250 is also coupled to ALICE so that the operation of BOB and ALICE are synchronized. Controller 250 also has an RNG 252 for randomly choosing the modulation states for phase modulator 220 in the manner described below.

With continuing reference to FIG. 2, in the operation of QKD system 101 and in particular assembly 100, controller 250 activates light source 212 to emit light pulses P0, which travel down optical fiber section F1 coupled to the light source. The light pulses P0 in optical fiber section F1 enter optics assembly 100 via port P1. In an example embodiment, pulses P0 are attenuated by the optional optical attenuator 103, if this element is present. The (attenuated) light pulses P0 then pass through polarizer 102, which polarizes the pulses in a direction such that they would pass through polarizing beamsplitter 108. Polarizer 102 is not needed if light source 212 is arranged so that the polarization of emitted light pulses P0 is already the same the polarization direction of polarizer 102.

The now-attenuated pulses P0 then proceed to 50:50 beamsplitter 106, which splits each pulse P0 into pulses PA and PB, with pulse PB directed to port P2, while the other pulse PA continues along axis Al to polarizing beamsplitter 108 and then therethrough. Pulse PB travels over optical fiber section F2, passes through phase modulator 220 (which at this point simply transmits the pulse without modulating its phase), travels over optical fiber section F3 and through port P3 to polarizing beamsplitter 108, where it is directed along optical axis A1 to follow behind pulse PA. Optical fiber section F3 is twisted such that the polarization of light entering the fiber section from port P2 is rotated by 900 as compared to light leaving the fiber section at port P3.

Pulses PA and PB, which are now orthogonally polarized and separated with pulse PA in the lead, pass through optional optical filter 110, if this element is present. The pulses then leave assembly 100 via port P4 and enter the quantum channel i.e., optical fiber F4.

At Alice, one of the pulses (say, PB) is randomly phase modulated by phase modulator 70 using a phase modulation randomly selected from a set of four possible phase modulations. The polarizations of pulses PA and PB are also rotated by 90° at ALICE upon reflection from Faraday mirror 72. Pulses PA and PB are attenuated down to single-photon level (i.e., an average number of photons per pulse equal to or less than one) by attenuator 68 operably coupled to controller 80. The attenuated pulses then travel back to BOB over optical fiber F4 and re-enter assembly 100 via port P4. The pulses pass through optional optical filter 110 (if present) and to polarizing beamsplitter 108. Pulse PA is now directed by polarizing beamsplitter 108 to pass through port P3 and to proceed to phase modulator 220 via optical fiber section F3, and then back to port P2 via optical fiber section F2. While pulse PA is passing through phase modulator 220, controller 250 activates the phase modulator to impart a random phase selected from the aforementioned set of four possible phase modulations, i.e., from the same phase modulations selectable at ALICE. Meanwhile, pulse PB travels directly through polarizing beam splitter 108, and the two pulses are combined at 50:50 beamsplitter 106 to form a recombined pulse P0′ (not shown). The combined pulse is then detected at SPD 232, and the detection event (or the lack of a detection event, based on an expected arrival time) is recorded in controller 250.

Secure Use of Single SPD at Bob

A conventional realization of the BB84 protocol assumes the use of four possible modulation states for phase modulation at ALICE, two possible modulation states at BOB, and the use of two single photon detectors at BOB. If ALICE uses a set of four modulation states (modulations): say {−3π/4, −π/4, π/4 or 3π/4}—BOB can randomly select a modulation from two of these possible modulations e.g., {−π/4 and π/4}.

With reference again to FIG. 1, this means that when the phase difference is 0, the signal goes to detector D1 and when the phase difference is π, the signal goes to detector D2. Unfortunately, as mentioned above, the elimination of one of the detectors compromises the security of the system because an eavesdropper can obtain information about the exchanged key by observing clicks at one remaining detector. To date, the elimination of an SPD system has not been much of a concern because QKD systems have been for the most part relegated to the laboratory. However, for a commercial QKD system, it is important to keep the cost of goods sold (COGS) as low as possible, particularly when the technology is nascent.

To keep the single SPD QKD system 101 secure, one has to randomly switch between two sets of bases at Bob. In practice, this means using one RNG at BOB, but using four modulation states for BOB's phase modulator 220. This can be thought of as a modified version of the BB84 protocol that is better suited for a single-SPD QKD system than existing protocols. Mathematically, it is identical to BB84.

In the present invention, the phase modulation at BOB is performed in with the same modulation states available to Alice. Referring to the example embodiment of the invention shown in FIG. 2, in operation controller 80 at ALICE stores values for the four possible modulation states of phase modulator 70. Controller 80, with the help of RNG 82, randomly picks one phase at a time for each quantum signal to be modulated, thereby imparting a first modulation to the quantum signal. Controller 250 at BOB also stores values of the set of four possible modulation states for phase modulator 220, and randomly picks one at a time with the help of RNG 252 to impart a second modulation to the quantum signal.

The use of a single SPD 232 at BOB, however, can affect the quantum security of QKD system 101. For example, such an implementation does not allow one to perform a coincidence rate check between different SPDs. This means that, since the QKD system cannot easily detect the presence of an eavesdropper, controller 80 should keep the level of attenuation at optical attenuator 68 to that required by the absolute security approach—in particular, the average number of photons per pulse (quantum signal) must be equal to or less than the channel transmittivity. Here, it is assumed that the channel is formed by the optical fiber F4, which connects the ALICE and BOB QKD stations and carries at least the quantum signal.

Measuring Coincident Clicks

One of the parameters that BOB can monitor to increase the security of the system is the number of coincidence clicks in two SPDs. However, if one SPD is omitted, BOB is no longer capable of monitoring the coincidence, so the question to be addressed is how to assure the level of security is preserved using only one SPD.

To address this question, it should be noted that the most powerful attack known today is the so-called photon-number-splitting (PNS) attack, wherein an eavesdropper (EVE) splits off one photon out of multiple photon pulse and stores the photon in her quantum memory. Then, during the privacy discussion session she learns the basis ALICE used for encoding her secure bit, takes the photon from her quantum memory, and obtains the value of the secret bit simply by measuring the state of the photon in the correct basis. Any two-photon attacks without quantum memory are less powerful and do not introduce significant threat. (see S. Félix, N. Gisin, A. Stefanov, H. Zbinden, “Faint laser quantum key distribution: eavesdropping exploiting multiphoton pulses,” J. Mod. Optics 48, 2009 (2001)).

Fortunately for BOB, in a PNS attack EVE cannot increase the power of the signal she must send to BOB. Since EVE does not know the state of the photon, all she can do is to deliver the photon without attenuation using, say, quantum teleportation protocol. It is safe to conclude that the security of the scheme is preserved even if only one detector is used and the ultimate security criterion (i.e., the mean photon number used by Alice being equal to the channel transmittivity) is fulfilled.

To complete the analysis, pulses containing three and more photons must be taken into account. If more than two photons are found in a pulse, EVE can measure the state directly, albeit with some probability. Thus, in principle, she can take as advantage low quantum efficiency of the detector. If a two-SPD scheme is used, measuring the coincidence click rate can be used as an additional security parameter. A single-SPD scheme cannot measure coincidence click rate and so is a drawback of the scheme. However, numerical analysis shows that a PNS attack is powerful only if the mean photon number used by Alice is high compared with the number dictated by absolutely security model. Thus, a single-SPD scheme can be considered as secure as the two-SPD scheme if the mean photon number is kept low in accordance with the absolutely security model. The only significant difference is that the single-SPD scheme has an additional 3 dB loss due to the absence of one detector and because of basis flipping. If a higher photon number is used for encryption, the single-SPD scheme becomes vulnerable faster than the two-SPD scheme since the latter has an additional security parameter, namely the coincidence click rate.

Table 1 below illustrates the possible outcomes of detection events at SPD 232 based on the possible modulation states at BOB and ALICE in QKD system 101. Table 1 is based on an example set of four possible phase modulation sums of {0, π, π/2 and 3π/2} derived from randomly selecting a phase modulation at ALICE and BOB from the phase modulation set {−3π/4, −π/4, π/4, and 3π/4}. In practice, any four phase modulations having a π/2 increment can be used. In Table 1, a “1” means that detector 232 yields a click, “0” means that detector 232 does not yield a click, and “x” means that there is an equal probability detector 232 will yield or not yield a click.

TABLE 1

| Alice | Bob | | Detection at |
|---|---|---|---|
| phase | phase | Sum of | detector |
| modulation | modulation | phases | 232 |
| 3π/4 | 3π/4 | 3π/2 | x |
| π/4 | π/4 | π/2 | x |
| −3π/4 | 3π/4 | 0 | 1 |
| −π/4 | π/4 | 0 | 1 |
| −π/4 | −π/4 | −π/2 | x |
| 3π/4 | −π/4 | π/2 | x |
| −3π/4 | −π/4 | −π | 0 |
| −π/4 | −π/4 | −π/2 | x |
| π/4 | −3π/4 | −π | 0 |

Depending on the relative phases imparted to pulses PA and PB, the recombined pulse P0′ will or will not proceed to SPD 232 via port P5. The arrival of a recombined pulse at SPD 232 is recorded by controller 250 as a click. The clicks are then processed using known techniques (e.g., sifting, error correction and privacy amplification), to create a secret quantum key shared by BOB and ALICE.

Optional optical filter 110 is present to block light generated by Raman scattering in optical fiber when other wavelengths are multiplexed (for example, the public discussion, synchronization, or other traffic). Without optical filter 110, light from Raman scattering can return to BOB and activate detector SPD 232 to create false detection events when other wavelengths are multiplexed. Also, optical filter 110 is designed to block photons generated by the SPD during a detection event from leaving BOB. Such photons may contain information about what is happening inside of BOB. In an example embodiment, optical filter 110 passes the quantum signal wavelength (e.g., 1550 nm) while blocking all other wavelengths. In another example embodiment, optical filter 110 passes both the quantum signal wavelength (e.g., 1550 nm) as well as another wavelength such as for the timing and synchronization (e.g., 1310 nm), while blocking other wavelengths. In an example embodiment, optical filter 100 has a bandwidth of about 200GHz centered about the quantum signal frequency.

Note that optical assembly 100 of FIG. 3 operates in the same way as FIG. 2, except that polarizer 102 is external to housing 116. Also, it should be noted that in the operation of QKD system 101, in an alternative embodiment, the same pulse is modulated by Bob and Alice. This is because it is only the relative phase of the interfered pulses that matters, not the phase imparted to any one pulse in particular.

The various embodiments of optical assembly 100 described above are advantageous in that they relatively inexpensive and easy to manufacture. Further, the modular nature of optics assembly 100 makes it easier to integrate and manufacture a QKD station for a commercial QKD system. Optical assembly 100 is also more compact than prior art assemblies so that the BOB QKD station in the QKD system can be made small.

One-Way System Example Embodiment

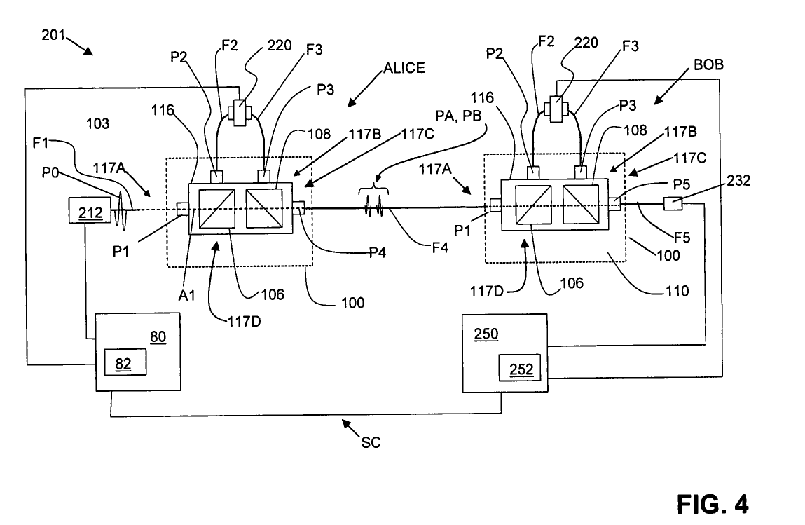

FIG. 4 illustrates an example embodiment of a single-SPD one-way QKD system 401 that employs optical assembly 100. In FIG. 4, like elements are given like reference numbers. For one-way system 401, light source 212 can either be a weak coherent pulses source (combination of laser and VOA), or a single photon source. In the case where light source 212 is a single photon source, the problem of double clicks is not so crucial.

In QKD system 401, both ALICE and BOB are formed from slightly modified versions the above-described bulk-optics assembly 100. Light source 212 is now optically coupled to input port P1 at Alice via optical fiber section F1, and SPD 232 is optically coupled to port P5 via optical fiber section F5 at BOB.

Alice also includes a controller 80 operably coupled to light source 212 to control the generation of pulses P0. Controller 80 also includes an RNG 82 that drives ALICE's modulator 220 as described above in connection with QKD system 101. Controllers 250 and 80 are coupled by a synchronization (“sync”) channel SC that coordinates the operation of the ALICE and BOB. In an example embodiment, sync channel SC travels over optical fiber link F4 connecting ALICE and BOB.

In the foregoing Detailed Description, various features are grouped together in various example embodiments for ease of understanding. The many features and advantages of the present invention are apparent from the detailed specification, and, thus, it is intended by the appended claims to cover all such features and advantages of the described apparatus that follow the true spirit and scope of the invention. Furthermore, since numerous modifications and changes will readily occur to those of skill in the art, it is not desired to limit the invention to the exact construction, operation and example embodiments described herein. Accordingly, other embodiments are within the scope of the appended claims.

1. A method of using a single single-photon detector (SPD) in a quantum key distribution (QKD) system, comprising:
modulating a phase of a quantum signal a first time at a first QKD station by applying a first phase modulation randomly selected from a set of four possible phase modulations; and
at a second QKD station operably coupled to the first QKD station and having the single SPD, modulating the phase of the quantum signal a second time by applying a second phase modulation randomly selected from the set of four possible phase modulations.

2. The method of claim 1, further including forming a quantum key by:
recording the first and second phase modulations for each of a plurality of quantum signals and forming a sifted key therefrom;
performing error correction on the sifted key; and
performing privacy amplification on the error-corrected key to form the quantum key.

3. A method of detecting quantum signals in a quantum key distribution (QKD) station having a single single-photon detector (SPD), comprising:
applying a first phase modulation to each quantum signal at a first QKD station operably coupled to a second QKD station;
applying a second phase modulation to each quantum signal at the second QKD station;
detecting the twice-modulated quantum signal with the single SPD; and
wherein the first and second phase modulations are each randomly selected from one set of four possible phase modulations.

4. The method of claim 3, including:
sending the once-modulated quantum signal through a bulk-optics assembly in the first QKD station, the bulk-optics assembly adapted to receive the once-modulated quantum signal, provide said second phase modulation to form the twice-modulated quantum signal, and directing the twice-modulated quantum signal to the single SPD.

5. The method of claim 3, further including forming a quantum key by:
recording the first and second phase modulations for each of a plurality of quantum signals to forming therefrom a sifted key;
performing error correction on sifted key; and
performing privacy amplification on the error-corrected key to form the quantum key.

6. The method according to claim 3, wherein the first QKD station includes an optical assembly consisting of two beamsplitters.

7. The method according to claim 3, wherein the first and second QKD stations each include an optical assembly consisting of two beamsplitters.
